(19) United States
(12) Patent Application Publication
(10) Pub. No.: US 2025/0348161 A1
(43) Pub. Date: Nov. 13, 2025

(54) INFORMATION PROCESSING DEVICE AND CONTROL METHOD FOR INFORMATION PROCESSING DEVICE

(71) Applicant: CANON KABUSHIKI KAISHA, Tokyo (JP)

(72) Inventor: ATSUSHI SUGAWARA, Kanagawa (JP)

(21) Appl. No.: 19/200,462

(22) Filed: May 6, 2025

(30) Foreign Application Priority Data
May 9, 2024 (JP) 2024-076732

(51) Int. Cl. G06F 3/038; G06F 3/01; G06F 3/16

(52) U.S. Cl. CPC G06F 3/0383; G06F 3/013; G06F 3/016; G06F 3/16; G06F 2203/0331

(57) ABSTRACT

An information processing device connected to or integrated with a head-mounted display device, includes: a processor; and a memory storing a program which, when executed by the processor, causes the information processing device to: execute notification processing of notifying a user of a state of a controller for controlling the head-mounted display device by the controller or notifying the user of the state of the controller by the head-mounted display device; and execute control processing of controlling a display of the controller to have first brightness when the controller notifies the state of the controller, and of controlling the display of the controller to have second brightness darker than the first brightness when the head-mounted display device notifies the state of the controller.

### BACKGROUND

### Technical Field

The present disclosure relates to an information processing device and a control method for the information processing device.

### Description of the Related Art

Operation units of various devices and a controller for operating the various devices are equipped with an LED, a display panel, and the like, and can give various notifications to a user. On the other hand, a technique for suppressing wasteful power consumption by an LED, a display panel, and the like has been proposed.

JP 2003-337571 A discloses a technique for reducing power consumption in an image-forming device by adjusting brightness of an LED according to brightness around the device detected by a light amount detection sensor.

JP 2011-209669 A discloses a technique in which it is determined whether a detection result of a light amount detection sensor satisfies a lighting condition of a display unit according to a time zone, thereby optimally holding luminance of the display unit in response to a temporary light amount change.

However, in a controller wirelessly connected to a display device such as a head-mounted display (HMD), determining brightness of the LED, the display unit, and the like based on ambient brightness may waste power of the controller. In a case where the user is wearing the HMD, although notification to the user is possible via the display unit of the HMD, the controller lights up according to the surrounding brightness to notify the user, thereby consuming wasteful power.

### SUMMARY

The present disclosure provides a technique for reducing power consumption of a controller for operating a head-mounted display device.

An information processing device according to the present disclosure is an information processing device connected to or integrated with a head-mounted display device, including: a processor; and a memory storing a program which, when executed by the processor, causes the information processing device to: execute notification processing of notifying a user of a state of a controller for controlling the head-mounted display device by the controller or notifying the user of the state of the controller by the head-mounted display device; and execute control processing of controlling a display of the controller to have first brightness when the controller notifies the state of the controller, and of controlling the display of the controller to have second brightness darker than the first brightness when the head-mounted display device notifies the state of the controller.

Further features of the present disclosure will become apparent from the following description of exemplary embodiments with reference to the attached drawings.

### BRIEF DESCRIPTION OF THE DRAWINGS

FIGS. 1A and 1B are external views of an HMD.

FIGS. 2A to 2C are external views of a controller of the HMD.

FIG. 3 is a diagram illustrating a specific example of a light emission pattern of an LED display unit of the controller.

FIG. 4 is a diagram illustrating a configuration of the HMD and the controller.

FIG. 5 is a flowchart illustrating notification control processing according to a first embodiment.

FIG. 6 is a diagram illustrating an example of an icon for notifying a state of the controller.

FIG. 7 is a flowchart illustrating notification control processing according to a second embodiment.

FIG. 8 is a flowchart illustrating notification control processing according to a modification of the second embodiment.

### DESCRIPTION OF THE EMBODIMENTS

### First Embodiment

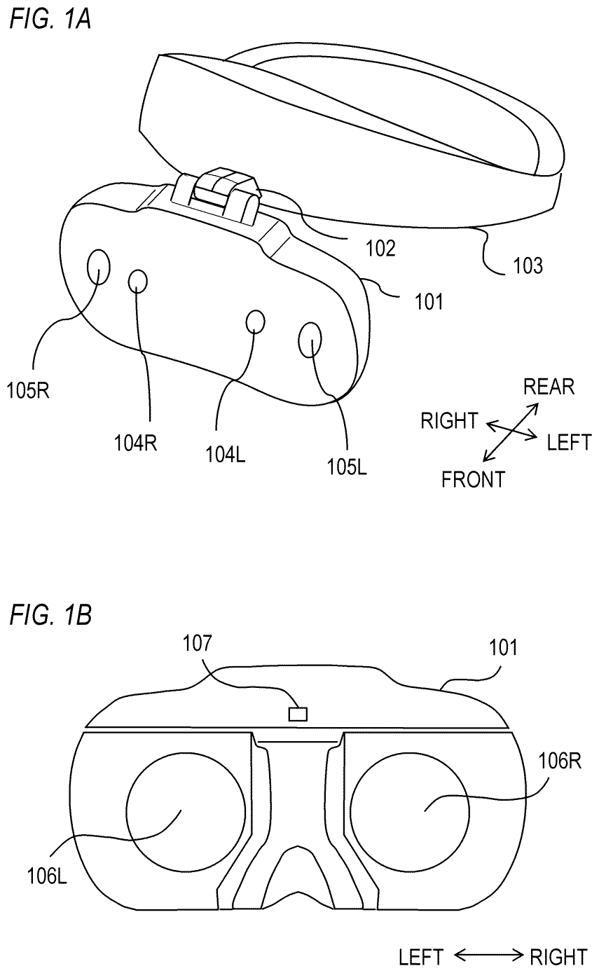

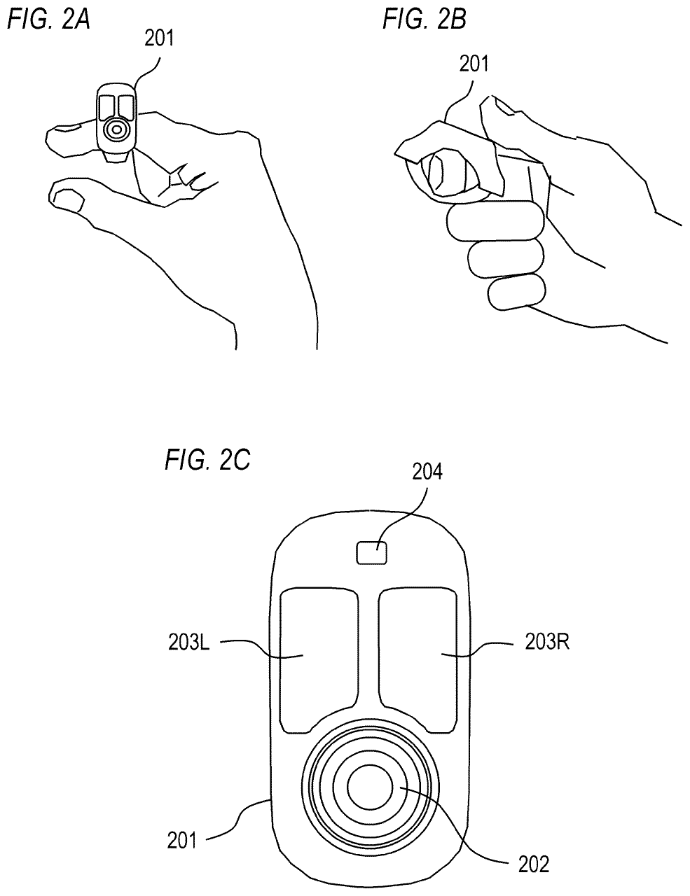

Hereinafter, embodiments of the present disclosure will be described with reference to the drawings. FIGS. 1A and 1B are external views of a head-mounted display device (HMD) 101 according to the present disclosure. FIGS. 2A to 2C are external views of a controller 201 for controlling the HMD 101.

FIG. 1A is a perspective view of the HMD 101 as viewed from the front side opposite to the user side (rear side) when the user wears the HMD 101. FIG. 1B is a view of the HMD 101 as viewed from the rear side.

In FIG. 1A, the HMD 101 is connected to a wearing portion 103 via a connecting portion 102. The connecting portion 102 is, for example, a hinge. The wearing portion 103 is a member that is worn on the user's head like a headband. By wearing the wearing portion 103 on the head, the user can place the HMD 101 in front of the user's eyes.

When the HMD 101 is placed in front of the user's eyes, the user can open the connecting portion 102 and move the HMD 101 in an upward motion to directly view the real space in front of the user without using the HMD 101. A state in which the HMID 101 is flipped up is called “flip-up”.

As illustrated in FIG. 1A, the HMD 101 includes an imaging camera 104L, an imaging camera 104R, an alignment camera 105L, and an alignment camera 105R. Using these cameras, the HMD 101 can allow the user to experience mixed reality (MR), which displays computer graphics (CG) superimposed on the real space seen by the user.

A pair of left and right imaging cameras 104L and 104R are stereo cameras that capture images of the real space around the user. In addition, a pair of left and right alignment cameras 105L and 105R are stereo cameras used to obtain information on the position and orientation of the HMD 101 by extracting markers and object features used for alignment from the captured images.

As illustrated in FIG. 1B, the HMD 101 includes a left display unit 106L and a right display unit 106R. The display units 106L and 106R display images captured by the imaging cameras 104L and 104R. The user can look into the display units 106L and 106R and observe the displayed images. The display units 106L and 106R each include a display element such as a liquid crystal display or an OLED, and a display optical system such as a prism and a lens for magnifying and guiding an image displayed on the display element. The positions of the display units 106L and 106R can be adjusted to match a width between the left and right eyes of the user.

In the following description, the HMD 101 is assumed to be a video see-through HMD, but may be an optical see-through HMD. In a case where the HMD 101 is a video see-through HMD, the real space viewed by the user is an image of the real space captured by the imaging cameras 104L and 104R and displayed on the display units 106L and 106R. In a case where the HMD 101 is an optical see-through HMD, the real space viewed by the user is the real space viewed through the transmission type display units 106L and 106R.

The HMD 101 further includes a proximity sensor 107. The proximity sensor 107 can detect that the user's face has approached (contact state of the face) in a non-contact manner. In a case where the proximity sensor 107 detects approach of the user's face, the HMD 101 determines that the HMD 101 is disposed in front of the user's eyes. Hereinafter, a state in which the HMD 101 is arranged in front of the eyes is described as a contact state of the eyes. The contact state of the user's eyes includes a state in which the user's eye and the HMD 101 are close to each other.

In a case where the proximity sensor 107 has not detected approach of the user's face, the HMD 101 determines that the HMD 101 is not arranged in front of the user's eyes. Hereinafter, a state in which the HMD 101 is not arranged in front of the eyes is described as a non-contact state of the eyes.

For example, a state in which the user wears the HMD 101 and looks into the display units 106L and 106R is determined as the contact state of the eyes. In addition, the state in which the HMD 101 is removed from the user's head and the flip-up state are determined to be the non-contact state of the eyes. Note that, in a case where the HMD 101 further includes a line-of-sight sensor (not shown), the line of sight of the user may be detected. In this case, the contact state of the eyes may be determined when not only the contact of the eyes of the user but also the line of sight of the user is detected. In this case, when the line of sight of the user is not detected, it is determined as the non-contact state of the eyes. Note that even if the line of sight is not detected, the contact state of the eyes may be determined when the eye of the user is detected by the camera or the like of the HMD 101. In this case, when the eye of the user is not detected, it is determined as the non-contact state of the eyes.

A relationship between the imaging cameras 104L and 104R, the alignment cameras 105L and 105R, and the display units 106L and 106R will be described. The HMD 101 can acquire information on the distance to an object existing in the space viewed by the user by stereo distance measurement from the outputs of the alignment cameras 105L and 105R, and can acquire information on the position and orientation of the HMD 101. The information on the position and orientation of the HMD 101 is information indicating which position and which direction the user is observing in the space.

Note that the HMD 101 may acquire the information on the position and orientation of the HMD 101 from an external personal computer (PC) or the like connected to the HMD 101 in a wired or wireless manner. The external PC can receive the images captured by the alignment cameras 105L and 105R from the HMD 101, calculate information on the position and orientation of the HMD 101, and transmit the information to the HMD 101.

The HMD 101 uses the acquired information of the position and orientation to render an optional CG (virtual object) in accordance with the position and orientation of the user's line of sight, combines the CG with the captured images of the imaging cameras 104L and 104R, and displays the combined image on the display units 106L and 106R. By the HMD 101 performing processing of combining and displaying the CG with the captured image at high speed, the user can have an MR experience as if a desired virtual object existed on the spot in the real space.

In the example of FIG. 1A, the HMD 101 includes the imaging cameras 104L and 104R and the alignment cameras 105L and 105R separately. The alignment cameras 105L and 105R have a wider angle of view than the imaging cameras 104L and 104R, and have a higher reading speed and a longer base length, thereby achieving highly accurate and highly fault-resistant alignment. Note that the HMD 101 may acquire the image for display and the information for alignment using the imaging cameras 104L and 104R instead of separately providing the alignment cameras 105L and 105R.

The controller 201 will be described with reference to FIGS. 2A to 2C. The controller 201 is, for example, a ring-type device, and has a battery (not shown) mounted therein. The controller 201 can detect an operation on an operation member such as a button, perform wireless communication with the HMD 101 by Bluetooth (registered trademark), and the like by power supplied from the battery.

FIGS. 2A and 2B are external views of the controller 201. In FIGS. 2A and 2B, the controller 201 is worn on the index finger of the right hand, but may be worn on a different finger such as the middle finger.

FIG. 2C is a plan view of the controller 201. The controller 201 includes a button 202 incorporating an optical track pad (OTP) and a pair of button switches 203L and 203R as operation members that receive an operation from the user. The controller 201 also includes an LED display unit 204.

The button 202 with the OTP built therein detects the contact of the user's finger, and accepts a tap operation to instantaneously make contact in a tapping manner and then release the contact, a swipe operation to make contact in a sliding manner with the finger on the surface, and the like. The user can move a cursor, select and move a virtual object, scroll a screen, and the like by various operations.

The button switches 203L and 203R are operation members to which various operations can be assigned. For example, a determination operation may be assigned to the button switch 203L, and a return or cancel operation may be assigned to the button switch 203R.

The LED display unit 204 is a display member that notifies the user of a status (state) of the controller 201. The LED display unit 204 internally includes chip LEDs of two colors of blue and orange. The light from the chip LED is guided to the LED display unit 204 via a light guide member. The controller 201 can notify the user of various states via the LED display unit 204 by various light emission patterns combining the lighting cycle, the duty ratio, and the emission color of the chip LED.

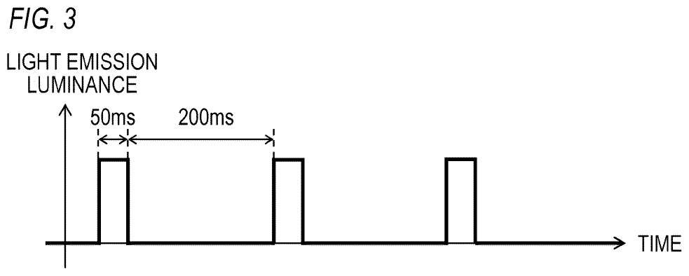

The light emission pattern of the LED display unit 204 of the controller 201 will be described with reference to FIG. 3. FIG. 3 is a diagram illustrating a specific example of a light emission pattern of the LED display unit 204 of the controller 201. In the graph illustrated in FIG. 3, a vertical axis represents light emission luminance, and a horizontal axis represents time. The light emission pattern illustrated in FIG. 3 repeats a cycle including a light-on time of 50 ms and a light-off time of 200 ms. That is, the light emission cycle is 250 ms, and the duty ratio is 20%. For example, when the remaining battery level (remaining power capacity) becomes lower than a predetermined threshold, the controller 201 notifies the user of a decrease in a remaining battery level by blinking the orange chip LED in the light emission pattern illustrated in FIG. 3.

Generally, since a battery having a large capacity also has a large physical size, increasing the battery capacity is opposite to downsizing of a mounted product. Since the ring-shaped controller 201 has a small battery capacity, it is desirable to save power as much as possible.

In order to suppress the power consumption of the controller 201, it is desirable to reduce the notification to the user using the LED display unit 204. On the other hand, it is desirable to notify the user of the state of the controller 201 such as the remaining battery level, the wireless connection state with the HMD 101, and the update status (ongoing/completed) of the internal firmware. Therefore, the HMD 101 realizes appropriate notification to the user while reducing battery consumption by controlling display on the LED display unit 204.

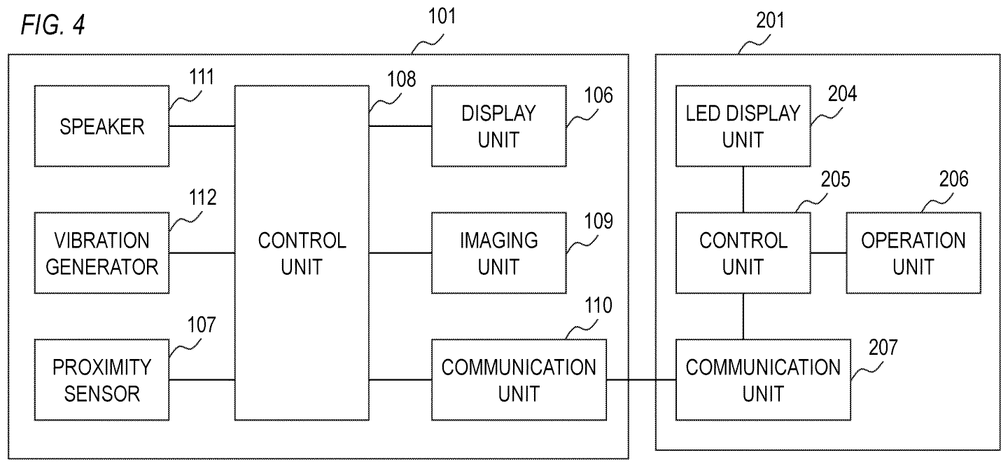

Configurations of the HMD 101 and the controller 201 will be described with reference to FIG. 4. The HMD 101 includes a control unit 108, a display unit 106, an imaging unit 109, a proximity sensor 107, a communication unit 110, a speaker 111, and a vibration generator 112. The control unit 108 can realize each function of the HMD 101 by controlling each configuration of the HMD 101. Note that, here, the HMD 101 will be described as an example of a head-mounted display device in which the information processing device is built in (integrated with), but the information processing device is not limited thereto. The information processing device connected to the head-mounted display device in a wired or wireless manner may be a smartphone, a tablet terminal, or a PC. In this case, a part of the processing of the HMD 101 to be described later may be performed by an information processing device connected to the head-mounted display device in a wired or wireless manner.

The display unit 106 corresponds to the display units 106L and 106R in FIG. 1B. The imaging unit 109 corresponds to the imaging cameras 104L and 104R and the alignment cameras 105L and 105R in FIG. 1A. The display unit 106, the imaging unit 109, and the proximity sensor 107 are the same as the corresponding configurations in FIGS. 1A and 1B, and thus detailed description thereof is omitted.

The communication unit 110 is a communication interface for communicating with the controller 201. The communication unit 110 is connected to a communication unit 207 of the controller 201 by wireless connection such as Bluetooth (registered trademark).

The speaker 111 is a voice output unit capable of outputting a voice that notifies the user of the state of the controller 201. The vibration generator 112 is, for example, a vibration motor, and can generate a specific vibration that notifies the state of the controller 201.

The controller 201 includes a control unit 205, an LED display unit 204, an operation unit 206, and a communication unit 207. The control unit 205 can realize each function of the controller 201 by controlling each configuration of the controller 201.

The operation unit 206 corresponds to the button 202 and the button switches 203L and 203R in FIG. 2C. The LED display unit 204 and the operation unit 206 have the same configuration as the corresponding configuration in FIG. 2C, and thus detailed description thereof is omitted.

The communication unit 207 is a communication interface for communicating with the HMD 101. The communication unit 207 is connected to the communication unit 110 of the HMD 101 by wireless connection such as Bluetooth (registered trademark).

The control unit 108 of the HMD 101 acquires information of a user operation on the controller 201 via the communication unit 110 and the communication unit 207, and executes processing according to the user operation. Furthermore, the control unit 108 can instruct the control unit 205 of the controller 201 to control the display state of the LED display unit 204, and the like.

On the other hand, when the operation unit 206 receives an operation from the user, the control unit 205 of the controller 201 transmits information on the user operation to the HMD 101 via the communication unit 207 and the communication unit 110. Furthermore, the control unit 205 can execute processing according to an instruction from the control unit 108 of the HMD 101. For example, the control unit 205 can adjust the brightness of the LED display unit 204 and turn off the LED display unit 204 by controlling a chip LED inside the LED display unit 204 according to an instruction from the control unit 108. The control unit 205 can notify the user of the state of the controller 201 by controlling the display state of the LED display unit 204 in accordance with an instruction from the control unit 108.

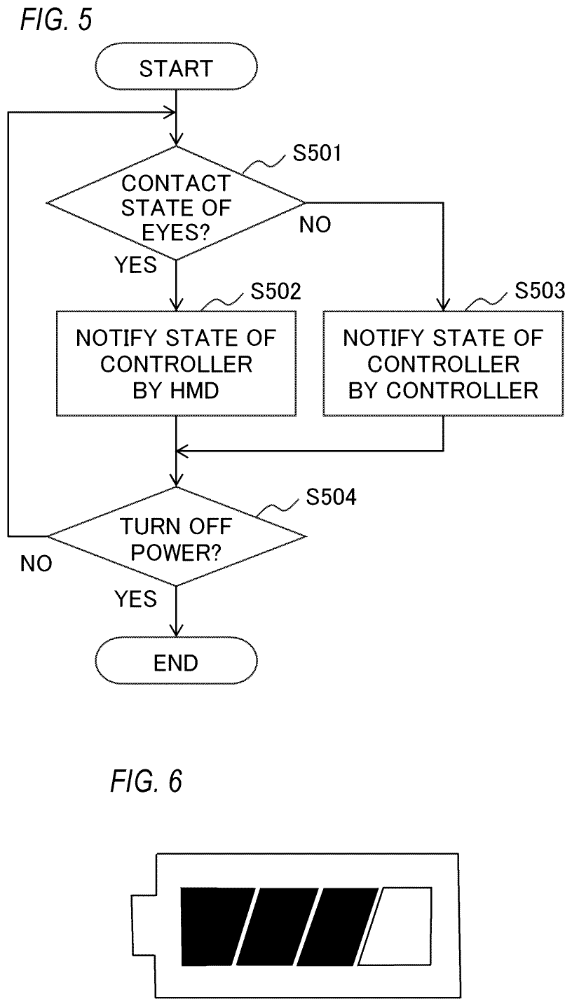

The notification control processing by the HMD 101 will be described with reference to FIG. 5. FIG. 5 is a flowchart illustrating notification control processing according to a first embodiment. The HMD 101 notifies the state of the controller 201 by the HMD 101 in a case where it is detected that the user is looking at the display unit 106, and notifies the state by the controller 201 in a case where it is not detected that the user is looking at the display unit 106.

The notification control processing illustrated in FIG. 5 is started when the HMD 101 and the controller 201 are powered on and the HMD 101 and the controller 201 are connected by Bluetooth (registered trademark) or the like.

In step S501, the control unit 108 uses the proximity sensor 107 to determine whether or not the HMD 101 is in the contact state of the eyes arranged in front of the eyes of the user. In the contact state of the eyes, the processing proceeds to step S502. In the case of the non-contact state of the eyes, the processing proceeds to step S503.

In step S502, the control unit 108 notifies the user of the state of the controller 201 by the HMD 101. The state of the controller 201 includes, for example, a remaining power capacity of the controller 201, a communication status between the controller 201 and the HMD 101, and the like.

The reason why the state of the controller 201 is notified to the user by the HMD 101 will be described. In step S502, the user is in the contact state of the eyes with respect to the HMD 101, and is in a state of looking into the display unit 106 and performing MR experience. Since the real space in front of the user's eyes is displayed on the display unit 106, the user can visually recognize the LED display unit 204 of the controller 201 worn on his/her finger. However, since the user looks into the display unit 106, the HMD 101 can notify the user of the state of the controller 201 using the display unit 106. When notifying the user of the state of the controller 201 using the display unit 106, the HMD 101 can suppress battery consumption of the controller 201 by turning off the LED display unit 204.

Notification of the state of the controller 201 by the HMD 101 will be described with reference to FIG. 6. FIG. 6 is a diagram illustrating an example of an icon for notifying the state of the controller 201. The icon illustrated in FIG. 6 indicates the remaining battery level of controller 201. For example, when the remaining battery level (remaining power capacity) of the controller 201 becomes lower than a predetermined threshold, the HMD 101 displays an icon indicating the remaining battery level illustrated in FIG. 6 on the display unit 106. The user can recognize that the remaining battery level is decreasing by visually recognizing the icon indicating the remaining battery level.

Note that the method of notifying the state of the controller 201 by the HMD 101 is not limited to the method of displaying an icon on the display unit 106. The HMID 101 may display a message such as “remaining battery level is low” on the display unit 106 to notify the user that the remaining battery level is decreasing.

Furthermore, the HMD 101 may recognize the controller 201 from image information of the imaging cameras 104L and 104R and the alignment cameras 105L and 105R, and display CG that makes the LED display unit 204 look shining. The HMD 101 acquires information on the positions of the controller 201 and the LED display unit 204 from the captured image, and superimposes the information on the position of the LED display unit 204 in the image of the real space to display the CG. The CG superimposed and displayed on the position of the LED display unit 204 is a virtual object that is turned on with normal brightness (first brightness) when the controller 201 makes various notifications and makes it appear as if the state of the controller 201 is being notified.

In a case where the CG is superimposed and displayed at the position of the LED display unit 204, the HMD 101 displays the CG simulating the light emission pattern according to the content of the notification. For example, in a case where the remaining battery level is lower than the predetermined threshold, the HMD 101 generates and displays CG for making the LED display unit 204 appear to emit orange light in the light emission pattern described in FIG. 3.

On the other hand, while the CG simulating the light emission pattern of the LED display unit 204 is displayed, the HMD 101 performs control such that the LED display unit 204 of the controller 201 is turned off without emitting light.

Note that the HMD 101 is not limited to the case of bringing the controller 201 into the turn-off state, and may perform control such that the brightness of the LED display unit 204 becomes brightness (second brightness) darker than normal brightness (first brightness) at the time of making various notifications. By making the brightness of the LED display unit 204 darker than usual, the power consumption of the controller 201 is reduced.

Furthermore, the HMD 101 may perform control so that the notification by the LED display unit 204 is dark to such an extent that the user can recognize it. In this case, the user can recognize both the notification by the HMD 101 and the notification by the controller 201.

By controlling the LED display unit 204 not to emit light, the HMD 101 can notify the user of the state of the controller 201 while suppressing the power consumption of the controller 201. In a case where the HMD 101 superimposes the CG on the position of the LED display unit 204 and displays the superimposed CG on the display unit 106, the light emission color, the blinking cycle, and the duty ratio of the light emission pattern can be freely set without being restricted by hardware such as power consumption or processing performance. The HMD 101 may notify the status of the controller 201 using distinct colors and distinct light-emission patterns.

The HMD 101 is not limited to the case where the CG for notifying the state of the controller 201 is superimposed on the position of the LED display unit 204, and can display the CG superimposed on a position corresponding to the position of the controller 201. For example, the HMD 101 may display a CG (virtual object) at a predetermined part of the controller 201 or in the vicinity of the controller 201.

The HMD 101 may notify the user of the state of the controller 201 by displaying an icon or a message on the display unit 106. The icon for notifying the state of the controller 201 is, for example, an icon indicating a remaining battery level illustrated in FIG. 6. The message for notifying the state of the controller 201 is, for example, a message such as “remaining battery level is low”. The HMD 101 may display an icon or a message notifying the state of the controller 201 at a predetermined position on the display unit 106 or at a position corresponding to the position of the controller 201.

In step S502, the control unit 108 may notify the user of the state of the controller 201 by outputting a warning sound or a voice from the speaker 111. Furthermore, the control unit 108 may notify the user of the state of the controller 201 by vibrating the HMD 101 with a specific vibration pattern using the vibration generator 112.

The control unit 108 may notify the user of the state of the controller 201 by optionally combining display of a CG, a message, and the like on the display unit 106, output from the speaker 111, and vibration by the vibration generator 112.

In step S503, the control unit 108 notifies the state of the controller 201 by the controller 201. In step S503, since the user is in a non-contact state of the eyes with respect to the HMD 101, there is a possibility that the user does not look into the display unit 106 and does not sense the sound from the speaker 111 and the vibration by the vibration generator 112. In a case where the user is in the non-contact state of the eyes with respect to the HMD 101, the control unit 108 causes the LED display unit 204 of the controller 201 to turn on with normal brightness, and causes the controller 201 to notify the state of the controller 201.

While the power of the HMD 101 is on, in steps S501 to S503, the control unit 108 switches whether to notify the notification from the controller 201 by the HMD 101 or by the controller 201 according to the contact state of the eyes of the user.

In step S504, the control unit 108 determines whether or not an operation of turning off the power of the HMD 101 has been detected. In a case where the operation of turning off the power is detected, the control unit 108 turns off the power of the HMD 101 and ends the notification control processing illustrated in FIG. 5. In a case where the operation of turning off the power is not detected, the processing returns to step S501.

In the above-described first embodiment, the HMD 101 switches whether to notify the user of the state of the controller 201 via the HMD 101 or via the controller 201, depending on the contact state of the eyes of the user. When notifying the user of the state of the controller 201 by the HMD 101, the HMD 101 controls the LED display unit 204 of the controller 201 to be darker than normal brightness. As a result, the user can recognize the notification from the controller 201 without interruption, and the controller 201 can reduce power consumption.

### Second Embodiment

The first embodiment is an embodiment in which whether to notify the user of the state of the controller 201 by the HMD 101 or to notify the user by the controller 201 is switched according to the contact state of the eyes of the user with respect to the HMD 101. On the other hand, in second embodiment, the HMD 101 switches whether to notify the user of the state of the controller 201 by the HMD 101 or to notify the user by the controller 201 according to the operation mode of the HMD 101.

The first embodiment illustrates an example in which the HMD 101 is used for so-called MR in which a CG is superimposed and displayed on an image of a real space viewed by the user. In the second embodiment, the HMD 101 is used not only for the MR but also for virtual reality (Virtual Reality, VR) in which only a virtual space is displayed on the display unit 106.

The HMD 101 according to the second embodiment has, as operation modes, an MR mode (first mode) in which a virtual object is fused with a real space and displayed, and a VR mode (second mode) in which a virtual reality image is displayed. The HMD 101 can be used by switching between the MR mode used for MR applications and the VR mode used for VR applications.

In the second embodiment, the HMD 101 switches the method of notifying the state of the controller 201 according to the operation mode. When used in the VR mode, the HMD 101 displays only the image of the virtual space without displaying the image of the real space on the display unit 106. Therefore, the controller 201 and the LED display unit 204 are not visually recognized by the user viewing the display unit 106. In the VR mode, the HMD 101 reduces power consumption of the controller 201 by controlling the controller 201 that is not viewed by the user to be in the turn-off state or to be darker than normal brightness.

Since the appearance and configuration of the HMD 101 and the controller 201 according to the second embodiment are similar to those of the first embodiment, the description thereof will be omitted. The HMD 101 according to the second embodiment may include an operation member (not shown) for switching the operation mode. When receiving an operation of switching the operation mode from the user via the operation member, the control unit 108 switches to the designated operation mode.

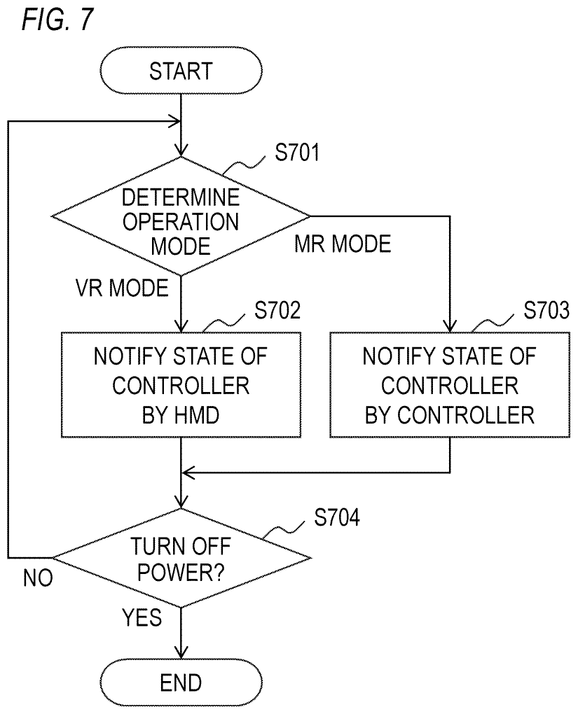

The notification control processing by the HMD 101 will be described with reference to FIG. 7. FIG. 7 is a flowchart illustrating notification control processing according to a second embodiment. Since the processing of steps S702 to S704 of FIG. 7 is the same as the processing of steps S502 to S504 of FIG. 5, detailed description thereof will be omitted. The processing in step S701 different from that in FIG. 5 will be described.

In step S701, the control unit 108 determines the operation mode. When the operation mode is the VR mode, since the user is not visually recognizing the controller 201 and the LED display unit 204, the notification using the LED display unit 204 is not recognized by the user. In a case where the operation mode is the VR mode, the control unit 108 proceeds to step S702 and notifies the user of the state of the controller 201 by the HMD 101.

In the VR mode, the control unit 108 can notify the user of the state of the controller 201 by displaying an icon or a message on the display unit 106. Furthermore, the control unit 108 may notify the user of the state of the controller 201 by sound from the speaker 111 or vibration from the vibration generator 112.

When the operation mode is the MR mode, the user can visually recognize the controller 201 and the LED display unit 204. When the operation mode is the MR mode, the control unit 108 proceeds to step S703 and notifies the user of the state of the controller 201 by the controller 201.

In the second embodiment described above, the HMD 101 switches the state of the controller 201 between notifying the user by the HMD 101 and notifying the user by the controller 201 according to the operation mode of the HMD 101. When notifying the user of the state of the controller 201 by the HMD 101, the HMD 101 controls the LED display unit 204 of the controller 201 to be darker than normal brightness. As a result, unnecessary light emission of the LED display unit 204 is suppressed in the VR mode, and the controller 201 can reduce power consumption. Also in the VR mode, the HMD 101 can notify the user of the state of the controller 201.

### Modification of Second Embodiment

A modification of the second embodiment is an example in which the second embodiment is combined with the first embodiment. In the modification, the HMD 101 switches whether to notify the state of the controller 201 by the HMD 101 or by the controller 201 according to the operation mode of the HMD 101 and the contact state of the eyes of the user with respect to the HMD 101.

In the case of the VR mode or in a case where it is detected that the user is viewing the display unit 106 of the HMD 101 in the MR mode (in a case of the contact state of the eyes), the HMD 101 according to the modification notifies the user of the state of the controller 201 by the HMD 101. In addition, in a case where the HMD 101 does not detect that the user is looking at the display unit 106 of the HMD 101 in the MR mode (in a case of the non-contact state of the eyes), the controller 201 notifies the user of the state of the controller 201.

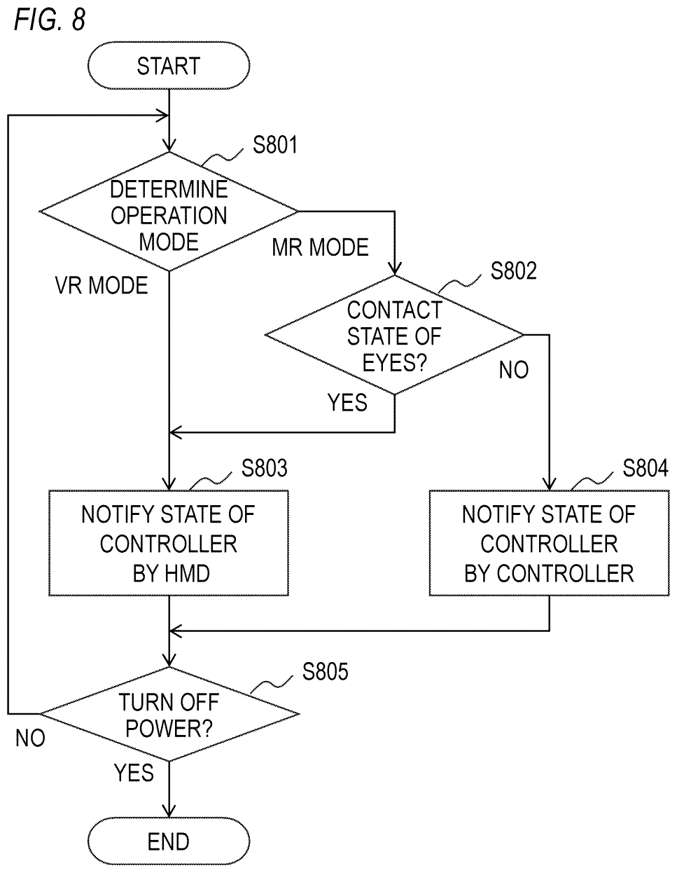

The notification control processing by the HMD 101 will be described with reference to FIG. 8. FIG. 8 is a flowchart illustrating notification control processing according to a modification of the second embodiment. Since the processing of steps S803 to S805 of FIG. 8 is the same as the processing of steps S502 to S504 of FIG. 5, detailed description thereof will be omitted. Steps S801 and S802 will be described.

In step S801, the control unit 108 determines the operation mode of the HMD 101 similarly to step S701 in FIG. 7. In a case where the operation mode is the VR mode, the control unit 108 proceeds to step S803 and notifies the user of the state of the controller 201 by the HMD 101. In a case where the operation mode is the MR mode, the control unit 108 proceeds to step S802.

In step S802, similarly to step S501 in FIG. 5, the control unit 108 determines whether or not the HMD 101 is in the contact state of the eyes in which the HMD 101 is arranged in front of the eyes of the user by using the proximity sensor 107. In the case of contact state of the eyes, the processing proceeds to step S803. In the case of the non-contact state of the eyes, the processing proceeds to step S804.

According to the modification of the second embodiment, as in the first and second embodiments, unnecessary light emission of the LED display unit 204 is suppressed, and the controller 201 can reduce power consumption.

According to the present disclosure, it is possible to reduce power consumption of a controller for operating a head-mounted display device.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-076732, filed on May 9, 2024, which is hereby incorporated by reference herein in its entirety.

What is claimed is:

1. An information processing device connected to or integrated with a head-mounted display device, comprising:
a processor; and
a memory storing a program which, when executed by the processor, causes the information processing device to:
execute notification processing of notifying a user of a state of a controller for controlling the head-mounted display device by the controller or notifying the user of the state of the controller by the head-mounted display device; and
execute control processing of controlling a display of the controller to have first brightness when the controller notifies the state of the controller, and of controlling the display of the controller to have second brightness darker than the first brightness when the head-mounted display device notifies the state of the controller.

2. The information processing device according to claim 1,
wherein the program, when executed by the processor, further causes the information processing device to execute detection processing of detecting that the user is looking at the display of the head-mounted display device, and
wherein, in the notification processing,
in a case where it is detected that the user is looking at the display of the head-mounted display device, the state of the controller is notified by the head-mounted display device, and
in a case where it is not detected that the user is looking at the display of the head-mounted display device, the state of the controller is notified by the controller.

3. The information processing device according to claim 2,
wherein, in the detection processing, in a case where a contact state of a user's face with respect to the head-mounted display device is detected, it is detected that the user is looking at the display of the head-mounted display device.

4. The information processing device according to claim 2,
wherein, in the detection processing, in a case where a contact state of a user's eyes with respect to the head-mounted display device is detected, it is detected that the user is looking at the display of the head-mounted display device.

5. The information processing device according to claim 2,
wherein, in the detection processing, in a case where a line of sight of the user is detected, it is detected that the user is looking at the display of the head-mounted display device.

6. The information processing device according to claim 1,
wherein the program, when executed by the processor, further causes the information processing device to execute switching processing of switching an operation mode of the head-mounted display device between a first mode in which a virtual object is fused with a real space and displayed and a second mode in which a virtual reality image is displayed, and
wherein, in the notification processing,
in the first mode, the state of the controller is notified by the controller, and
in the second mode, the state of the controller is notified by the head-mounted display device.

7. The information processing device according to claim 1,
wherein the program, when executed by the processor, further causes the information processing device to:
execute switching processing of switching an operation mode of the head-mounted display device between a first mode in which a virtual object is fused with a real space and displayed and a second mode in which a virtual reality image is displayed; and
execute detection processing of detecting that the user is looking at the display of the head-mounted display device, and
wherein, in the notification processing,
in a case where it is not detected that the user is looking at the display of the head-mounted display device in the first mode, the state of the controller is notified by the controller, and
in a case where the operation mode is the second mode, or in a case where it is detected that the user is looking at the display of the head-mounted display device in the first mode, the state of the controller is notified by the head-mounted display device.

8. The information processing device according to claim 1,
wherein the second brightness is brightness in an off state of the controller.

9. The information processing device according to claim 1,
wherein, in the notification processing, in a case where the state of the controller is notified by the head-mounted display device in the notification processing, an icon or a message notifying the state of the controller is displayed on the display of the head-mounted display device.

10. The information processing device according to claim 1,
wherein the program, when executed by the processor, further causes the information processing device to execute acquisition processing of acquiring information on a position of the controller, and
wherein, in the notification processing, in a case where the state of the controller is notified by the head-mounted display device, a virtual object notifying the state of the controller is superimposed on a position corresponding to the position of the controller and displayed on the display of the head-mounted display device.

11. The information processing device according to claim 10,
wherein the virtual object notifying the state of the controller is an object for making the controller appear to be turned on at the first brightness to notify the state of the controller.

12. The information processing device according to claim 1, further comprising:
a speaker,
wherein, in the notification processing, in a case where the state of the controller is notified by the head-mounted display device, the speaker outputs a sound for notifying the state of the controller.

13. The information processing device according to claim 1, further comprising:
a vibration generator,
wherein, in the notification processing, in a case where the state of the controller is notified by the head-mounted display device, the vibration generator generates specific vibration for notifying the state of the controller.

14. The information processing device according to claim 1,
wherein the state of the controller includes at least one of remaining power capacity of the controller and a communication status between the controller and the head-mounted display device.

15. A control method for an information processing device connected to or integrated with a head-mounted display device, the control method comprising:
notifying a user of a state of a controller for controlling the head-mounted display device by the controller or notifying the user of the state of the controller by the head-mounted display device; and
controlling a display of the controller to have first brightness when the controller notifies the state of the controller, and controlling the display of the controller to have second brightness darker than the first brightness when the head-mounted display device notifies the state of the controller.

16. A non-transitory computer readable medium that stores a program, wherein the program causes a computer to execute a control method for an information processing device connected to or integrated with a head-mounted display device, the control method comprising:
notifying a user of a state of a controller for controlling the head-mounted display device by the controller or notifying the user of the state of the controller by the head-mounted display device; and
controlling a display of the controller to have first brightness when the controller notifies the state of the controller, and controlling the display of the controller to have second brightness darker than the first brightness when the head-mounted display device notifies the state of the controller.
